(19) United States
(12) Patent Application Publication
(10) Pub. No.: US 2025/0353501 A1
(43) Pub. Date: Nov. 20, 2025

(54) Vehicle Control Apparatus and Method Thereof

(71) Applicants: Hyundai Motor Company, Seoul (KR); Kia Corporation, Seoul (KR)

(72) Inventors: Heung Seok Chae, Hwaseong-Si (KR); Ji Chang Kim, Hwaseong-Si (KR); Su Jung Yoo, Hwaseong-Si (KR); Yoo Suk Kim, Hwaseong-Si (KR)

(21) Appl. No.: 18/960,574

(22) Filed: Nov. 26, 2024

(30) Foreign Application Priority Data
May 17, 2024 (KR) 10-2024-0064597

(51) Int. Cl. B60W 30/18; B60W 30/12

(52) U.S. Cl. CPC B60W 30/18163; B60W 30/12; B60W 2552/10; B60W 2554/4042; B60W 2720/10

(57) ABSTRACT

An apparatus for controlling driving of a vehicle is introduced. The apparatus may comprise a memory storing at least one instruction, and a processor, wherein the at least one instruction is configured to, when executed by the processor, cause the apparatus to determine, based on a characteristic and a driving path of the vehicle, whether to make a lane change, identify a target space in an adjacent lane for the lane change based on a determination to make the lane change, a current position of the vehicle, a driving speed of the vehicle, and information about at least one other vehicle which is traveling in the adjacent lane, and perform, based on a bounding box corresponding to the target space and at least one box corresponding to the at least one other vehicle overlapping with each other, biased driving control toward the adjacent lane for the vehicle.

### CROSS-REFERENCE TO RELATED APPLICATION

This application claims the benefit of priority to Korean Patent Application No. 10-2024-0064597, filed in the Korean Intellectual Property Office on May 17, 2024, the entire contents of which are incorporated herein by reference.

### TECHNICAL FIELD

The present disclosure relates to a vehicle control apparatus and a method thereof, and more particularly, relates to technologies for controlling a host vehicle to selectively perform biased driving depending on a driving environment in a situation in which a lane change is desirable.

### BACKGROUND

The matters described in this Background section are only for enhancement of understanding of the background of the disclosure, and should not be taken as acknowledgment that they correspond to prior art already known to those skilled in the art.

As an autonomous driving control technology and/or a semi-autonomous driving control technology are/is developed, a stable driving technology for a host vehicle may gradually become more sophisticated. For example, various algorithms may be developed for making a lane change or performing biased driving control, based on various environments, such as a driving situation in an adjacent lane and driving information of the host vehicle, if a situation to make the lane change to the adjacent lane is identified while performing driving control for the host vehicle.

Meanwhile, although it is desirable to make the lane change, if it is impractical to quickly make the lane change due to at least one other vehicle in the adjacent lane, a movement line and a time for controlling the host vehicle may be unnecessarily wasted.

For example, in a situation in which it is impractical to make a lane change because a target space for the lane change is relatively small or there is a possibility of collision with another vehicle, if the current lane is kept to control the host vehicle, as a result, the lane change fails to be performed.

### SUMMARY

According to the present disclosure, an apparatus for controlling driving of a vehicle, the apparatus may comprise: a sensor configured to obtain a characteristic of a lane and a driving path of the vehicle; a memory storing at least one instruction; and a processor operatively coupled to the sensor and the memory, wherein the at least one instruction is configured to, when executed by the processor, cause the apparatus to: determine, based on the characteristic and the driving path, whether to make a lane change; identify a target space in an adjacent lane for the lane change based on a determination to make the lane change, a current position of the vehicle, a driving speed of the vehicle, and information about at least one other vehicle which is traveling in the adjacent lane; and perform, based on a bounding box corresponding to the target space and at least one box corresponding to the at least one other vehicle overlapping with each other, biased driving control toward the adjacent lane for the vehicle.

The apparatus, wherein the at least one instruction is configured to, when executed by the processor, cause the apparatus to: determine to make the lane change based on at least one of: a presence of a point at which the lane is ended within a specified distance of the lane, or identifying a situation of having the vehicle travel in the adjacent lane based on the driving path.

The apparatus, wherein the at least one instruction is configured to, when executed by the processor, cause the apparatus to: determine, based on information from the sensor and based on the target space not being determined, an average driving speed of the at least one other vehicle which is traveling in the adjacent lane; adjust the driving speed of the vehicle to follow the average driving speed; and perform lane keeping control for the vehicle traveling on the lane.

The apparatus, wherein the at least one instruction is configured to, when executed by the processor, cause the apparatus to: perform, based on the bounding box and the at least one box not overlapping with each other and a size of the bounding box being less than or equal to a specified size, the biased driving control for the vehicle.

The apparatus, wherein the at least one instruction is configured to, when executed by the processor, cause the apparatus to: determine, based on a width of the lane, a width of the vehicle, and a margin distance, a maximum value of an amount of the biased driving control; and perform the biased driving control for the vehicle to be adjacent to the adjacent lane by a value of the amount of the biased driving control, wherein the value is smaller than the maximum value, and wherein the amount of the biased driving control is set to be proportional to the width of the lane and be inversely proportional to the width of the vehicle and the margin distance.

The apparatus, wherein the at least one instruction is configured to, when executed by the processor, cause the apparatus to set the driving speed of the vehicle and the margin distance to be proportional to each other.

The apparatus, wherein the at least one instruction is configured to, when executed by the processor, cause the apparatus to: determine an expected arrival time point expected for the vehicle to reach the target space by the lane change; determine an adjacent other vehicle among the at least one other vehicle, wherein the adjacent other vehicle is expected to be present in front and behind of the vehicle at the expected arrival time point; determine expected driving information, wherein the expected driving information may comprise: an expected headway distance between the adjacent other vehicle and the vehicle with respect to an expected reach time point, a driving speed of the adjacent other vehicle, an expected distance to a point at which the lane is ended, a size of the bounding box corresponding to the target space, and an expected driving speed of the vehicle; determine real-time driving information, wherein the real-time driving information may comprise: a distance from the current position of the vehicle to the point at which the lane is ended, and a remaining time expected to reach, based on the driving speed, the point at which the lane is ended; and determine, based on the expected driving information and the real-time driving information, a second value of the amount of the biased driving control, wherein the second value of the amount of the biased driving control is less than or equal to the maximum value.

The apparatus, wherein the at least one instruction is configured to, when executed by the processor, cause the apparatus to determine the amount of the biased driving control to be inversely proportional to values included in the expected driving information and the real-time driving information.

The apparatus, wherein the at least one instruction is configured to, when executed by the processor, cause the apparatus to: determine a value of the amount of the biased driving control as a minimum value based on at least one of: a determination not to make the lane change, a size of the bounding box being greater than a specified size, or the bounding box and the at least one box not overlapping with each other, and perform, based on the determined value of the amount of the biased driving control, lane keeping control.

The apparatus, wherein the at least one instruction is configured to, when executed by the processor, cause the apparatus to suppress the biased driving control and make the lane change to the target space based on a size of the bounding box being greater than a specified size and based on the bounding box and the at least one box not overlapping with each other.

The apparatus, wherein the at least one instruction is configured to, when executed by the processor, cause the apparatus to: determine, based on information from the sensor, a real-time driving speed of a forward other vehicle among the at least one other vehicle, wherein the forward other vehicle is traveling in front of the vehicle; and determine a front box corresponding to the forward other vehicle to be inversely proportional to a magnitude of the real-time driving speed of the forward other vehicle.

The apparatus, wherein the at least one instruction is configured to, when executed by the processor, cause the apparatus to: determine, based on information from the sensor, a real-time driving speed of a following other vehicle among the at least one other vehicle, wherein the following other vehicle is traveling behind the vehicle; and determine a rear box corresponding to the following other vehicle to be proportional to a magnitude of the real-time driving speed of the following other vehicle.

The apparatus, wherein the at least one instruction is configured to, when executed by the processor, cause the apparatus to: determine, based on information from the sensor, a real-time driving speed of the at least one other vehicle; and determine the at least one box corresponding to the at least one other vehicle to be inversely proportional to a magnitude of a speed difference between the real-time driving speed and the driving speed of the vehicle.

According to the present disclosure, a method performed by an apparatus for controlling driving of a vehicle, the method may comprise: determining, based on a characteristic of a lane and a driving path of the vehicle obtained from a sensor, whether to make a lane change; identifying a target space in an adjacent lane for the lane change based on a determination to make the lane change, a current position of the vehicle, a driving speed of the vehicle, and information about at least one other vehicle which is traveling in the adjacent lane; and performing, based on a bounding box corresponding to the target space and at least one box corresponding to the at least one other vehicle overlapping with each other, biased driving control for the vehicle toward the adjacent lane.

The method, wherein the determining whether to make the lane change may comprise determining to make the lane change based on at least one of: a presence of a point at which the lane is ended within a specified distance of the lane, or identifying a situation of having the vehicle travel in the adjacent lane based on the driving path.

The method may further comprise: determining, based on information from the sensor and based on the target space not being determined, an average driving speed of the at least one other vehicle which is traveling in the adjacent lane; adjusting the driving speed of the vehicle to follow the average driving speed; and performing lane keeping control for the vehicle traveling on the lane.

The method may further comprise: performing, based on the bounding box and the at least one box not overlapping with each other and a size of the bounding box being less than or equal to a specified size, the biased driving control for the vehicle.

The method may further comprise: determining, based on a width of the lane, a width of the vehicle, and a margin distance, a maximum value of an amount of the biased driving control; and performing the biased driving control for the vehicle to be adjacent to the adjacent lane by a value of the amount of the biased driving control, where the value is smaller than the maximum value, wherein the amount of the biased driving control is set to be proportional to the width of the lane and be inversely proportional to the width of the vehicle and the margin distance.

The method may further comprise: setting the driving speed of the vehicle and the margin distance to be proportional to each other.

The method may further comprise: determining an expected arrival time point expected for the vehicle to reach the target space by the lane change; determining an adjacent other vehicle among the at least one other vehicle, wherein the adjacent other vehicle is expected to be present in front and behind of the vehicle at the expected arrival time point; determining expected driving information, wherein the expected driving information may comprise: an expected headway distance between the adjacent other vehicle and the vehicle with respect to an expected reach time point, a driving speed of the adjacent other vehicle, an expected distance to a point at which the lane is ended, a size of the bounding box corresponding to the target space, and an expected driving speed of the vehicle; determining real-time driving information, wherein the real-time driving information may comprise: a distance from the current position of the vehicle to the point at which the lane is ended, and a remaining time expected to reach, based on the driving speed, the point at which the lane is ended; and determining, based on the expected driving information and the real-time driving information, a second value of the amount of the biased driving control, wherein the second value of the amount of the biased driving control is less than or equal to the maximum value.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of components of a vehicle control apparatus according to an example of the present disclosure;

FIG. 2 shows an example of components and an operation of a vehicle control apparatus according to an example of the present disclosure;

FIG. 3 shows an example of a situation in which a vehicle control apparatus performs biased driving control or makes a lane change according to an example of the present disclosure;

FIG. 4 shows an example of a situation in which a vehicle control apparatus makes a lane change according to an example of the present disclosure;

FIG. 5 shows an example of a situation in which a vehicle control apparatus performs biased driving control according to an example of the present disclosure;

FIG. 6 shows an example of a situation in which a vehicle control apparatus performs biased driving control according to an example of the present disclosure;

FIG. 7 shows an example of a vehicle control method according to an example of the present disclosure;

FIG. 8 shows an example of a vehicle control method according to an example of the present disclosure; and

FIG. 9 shows an example of a computing system about a vehicle control apparatus or a vehicle control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In describing the components of the example according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

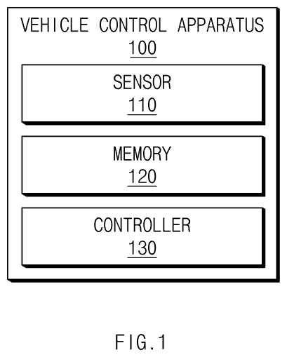

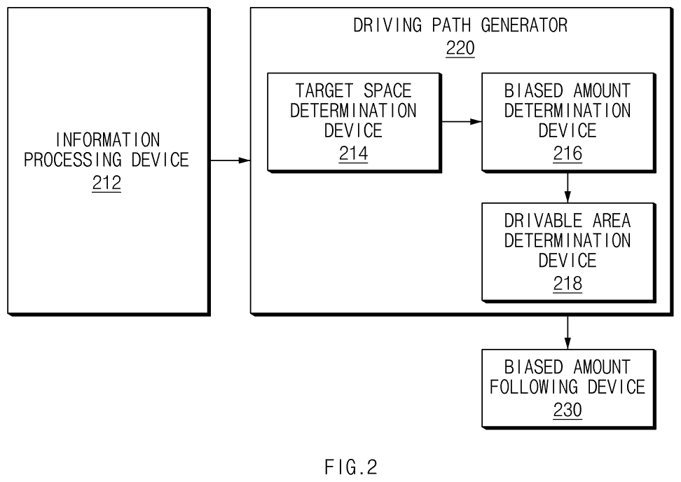

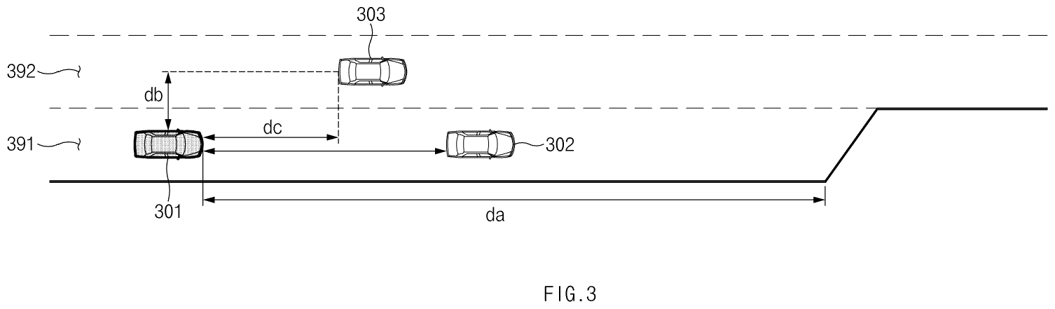

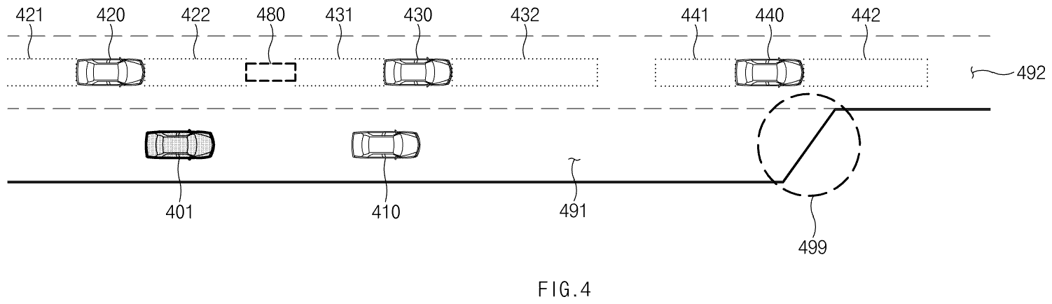

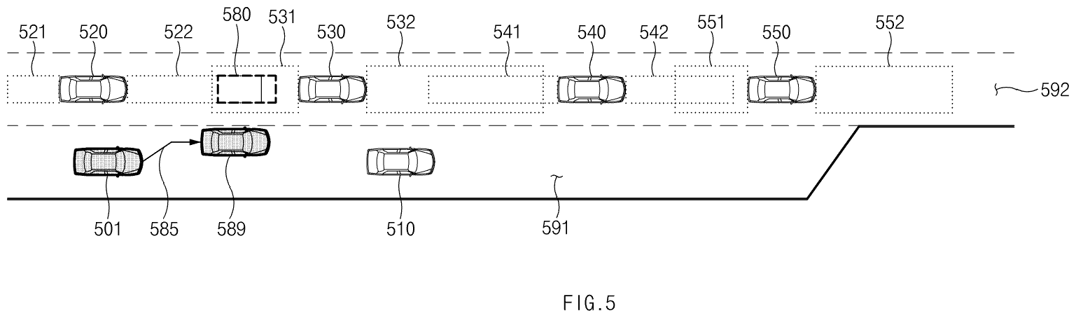

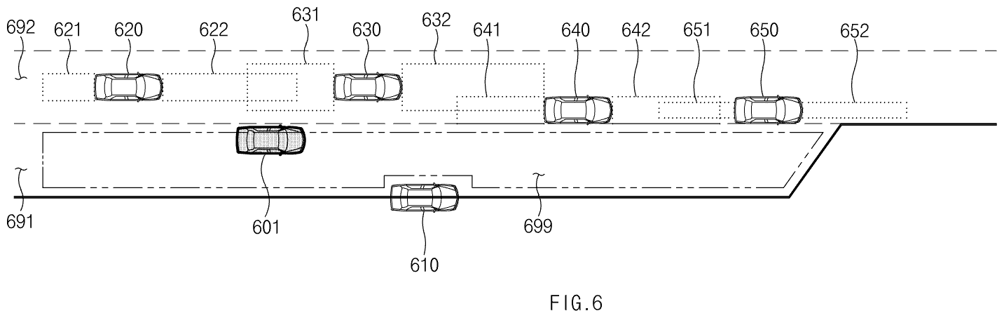

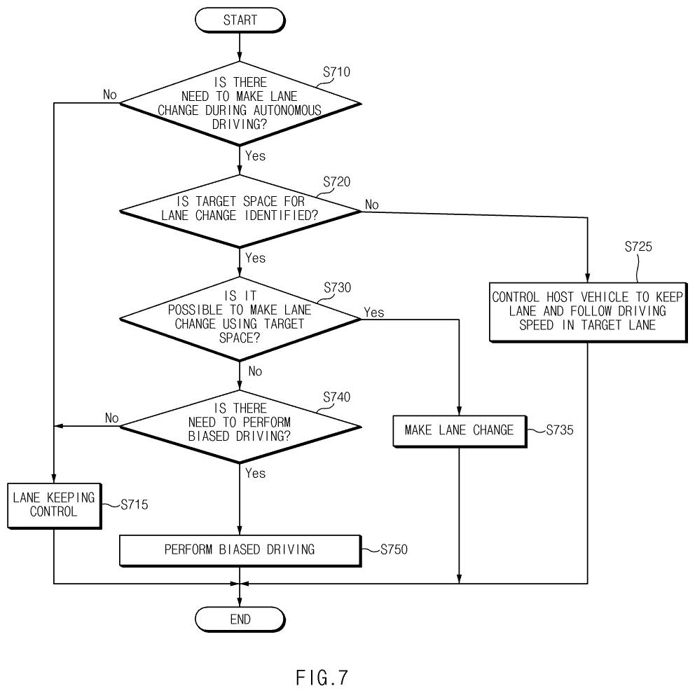

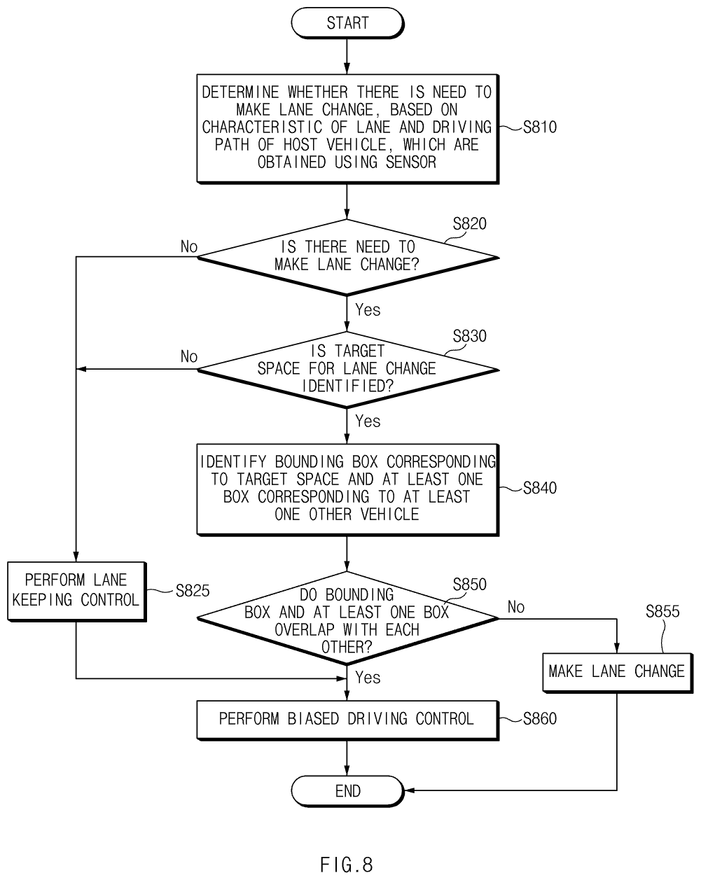

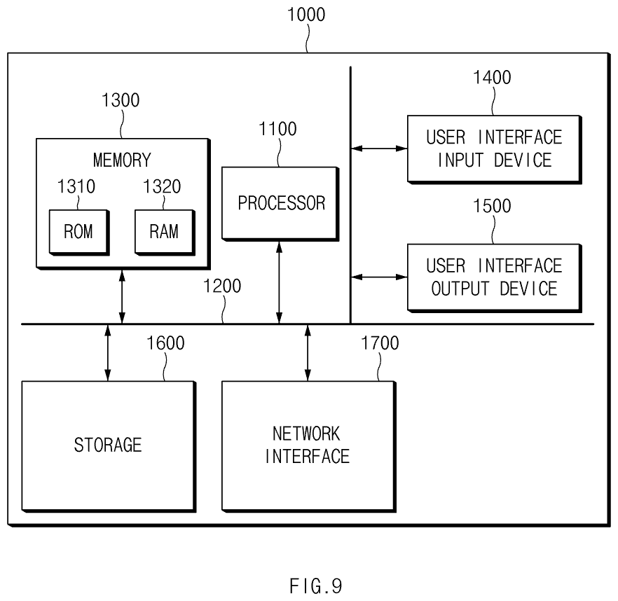

Hereinafter, examples of the present disclosure will be described in detail with reference to FIG. 1, FIG. 2, FIG. 3, FIG. 4, FIG. 5, FIG. 6, FIG. 7, FIG. 8, and FIG. 9.

FIG. 1 shows an example of components of a vehicle control apparatus according to an example of the present disclosure.

According to an example, a vehicle control apparatus 100 may include a sensor 110, a memory 120, and/or a controller 130. The components of the vehicle control apparatus 100, which are shown in FIG. 1, are exemplary, and examples of the present disclosure are not limited thereto. For example, the vehicle control apparatus 100 may further include components (e.g., at least one of a communication device, an interface, a display, or a notification device, or any combination thereof) which are not shown in FIG. 1.

According to an example, the sensor 110 may obtain (or sense) various pieces of information used for driving of a host vehicle.

For example, the sensor 110 may include at least one sensor including at least one of a camera, radio detection and ranging (radar), or light detection and ranging (LiDAR), or any combination thereof.

For example, the sensor 110 may obtain information about an external object (e.g., at least one of a person, a lane, an adjacent lane, another vehicle, a building, or a structure, or any combination thereof), using the at least one sensor.

For example, the sensor 110 may obtain information about a driving environment of the host vehicle. As an example, the sensor 110 may obtain information about at least one of a driving speed of the host vehicle, acceleration of the host vehicle, or a driving direction of the host vehicle, or any combination thereof.

For example, the sensor 110 may obtain information about whether there is at least one other vehicle and/or a driving state of the at least one other vehicle (e.g., at least one of a driving speed of the at least one other vehicle, acceleration of the at least one other vehicle, a driving direction of the at least one other vehicle, a separation distance from the host vehicle, or whether the at least one other vehicle is stopped, or any combination thereof). As an example, the at least one other vehicle may include other vehicles which are traveling in a lane in which the host vehicle is traveling and an adjacent lane of the lane and another vehicle which is being stopped in one area of the lane.

For example, the sensor 110 may obtain a characteristic of the lane in which the host vehicle is traveling. As an example, the characteristic of the lane may include information about a point (e.g., an end point 499 of FIG. 4) at which the lane is ended (or finished).

According to an example, the memory 120 may store a command or data. For example, the memory 120 may store one or more instructions, when executed by the controller 130, causing the vehicle control apparatus 100 to perform various operations.

For example, the memory 120 and the controller 130 may be implemented as one chipset. The controller 130 may include at least one of a communication processor or a modem.

For example, the memory 120 may store various pieces of information associated with the vehicle control apparatus 100. As an example, the memory 120 may store information about an operation history of the controller 130. As an example, the memory 120 may store information associated with states and/or operations of components (e.g., at least one of an engine control unit (ECU), the sensor 110, or the controller 130, or any combination thereof) of the host vehicle.

For example, the memory 120 may include different types of a plurality of storage devices. For example, the memory 120 may include at least one of a random-access memory (RAM) or an embedded multi-media card (eMMC), or any combination thereof.

As an example, the RAM may temporarily store data (e.g., driving data) about an operation of the vehicle control apparatus 100 and/or the host vehicle which is a control target of the vehicle control apparatus 100. The RAM may include, for example, at least one buffer. The vehicle control apparatus 100 may store, for example, at least one node divided by dividing pieces of data collected (or identified) while performing autonomous driving control for the host vehicle by a unit time in the RAM.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., features of a target space in an adjacent lane for a lane change) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of a target space in an adjacent lane for a lane change) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of a target space in an adjacent lane for a lane change) described herein.

Minimum risk maneuver (MRM) operation(s) may also be controlled, for example, based on one or more features (e.g., features of a target space in an adjacent lane for a lane change) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state.

A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of a target space in an adjacent lane for a lane change) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control.

For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc. One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of a target space in an adjacent lane for a lane change) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

As an example, the eMMC may include a built-in multimedia card. The eMMC may store, for example, data for a longer duration than the RAM. The eMMC may be implemented as, for example, a separate memory chip independent of the RAM.

According to an example, the controller 130 may be operatively connected with the sensor 110 and/or the memory 120. For example, the controller 130 may control operations of the sensor 110 and/or the memory 120.

For example, the controller 130 may obtain a characteristic of the lane and a driving path of the host vehicle using the sensor 110.

As an example, the controller 130 may identify a point at which the lane in which the host vehicle is traveling is ended, using the sensor 110.

As an example, the controller 130 may obtain a driving path using the sensor 110. The driving path may be, for example, an expected path to a destination defined by a setting of a user. The controller 130 may obtain (or identify) a driving path using pieces of driving information (e.g., a driving state of the host vehicle, a state of the road, shortest path information to the destination, or the like) obtained using the sensor 110.

For example, the controller 130 may identify whether there is a need to make a lane change, based on the characteristic of the lane and the driving path.

As an example, if there is a point at which the lane is ended within a specified distance of the lane in which the host vehicle is traveling, the controller 130 may identify that there is the need to make the lane change. In other words, if there is the point at which the lane is ended within the specified distance, with respect to a current position of the host vehicle, the controller 130 may determine that there is the need to make the lane change to an adjacent lane.

As an example, if identifying the situation of having to travel to the adjacent lane based on the driving path, the controller 130 may identify that there is the need to make the lane change. In other words, if identifying a situation in which the host vehicle wants to make a left turn or a right turn based on the driving path or checking that the host vehicle should travel in another lane because there is an intersection in front of the host vehicle, the controller 130 may determine that there is the need to make the lane change. The host vehicle may need to make a lane change in various situations to ensure safety, efficiency, and compliance with driving rules. For example, if a slower vehicle is detected in its current lane, the host vehicle might change lanes to maintain its desired speed. Lane changes may also be necessary to avoid obstacles, road debris, or construction zones ahead. For examples, the host vehicle may be approaching an on-ramp, off-ramp, or an exit, it may shift lanes to prepare for such maneuver. Further, the vehicle may change lanes in response to high traffic density, positioning itself in a faster-moving or less congested lane. If an emergency vehicle approaches from behind, the host vehicle may yield by switching lanes. These situations show practical reasons for autonomous driving of the host vehicle to adapt dynamically, enabling safe and efficient lane changes based on real-time conditions.

For example, if it is determined that there is the need to make the lane change, the controller 130 may identify a target space in the adjacent lane for the lane change using the current position of the host vehicle, the driving speed of the host vehicle, and information about at least one other vehicle which is traveling in the adjacent lane. The target space may refer to an identified area in the adjacent lane where the host vehicle plans to merge during a lane change. For examples, the target space may comprise a clear gap between two vehicles in the adjacent lane, offering enough distance for the host vehicle to safely merge without disrupting traffic flow. The target space may also be an open section in the adjacent lane where no vehicles are immediately present, providing a spacious and safe area for the maneuver. Moreover, the target space may comprise a position behind a slower vehicle in the adjacent lane, where the host vehicle may merge and maintain a safe following distance. Other examples of the target spaces may be areas created by vehicles in the adjacent lane slowing down, forming a temporary gap, or a position near an upcoming exit or turn, allowing the host vehicle to prepare for a transition to another roadway. These examples show various conditions under which safe merging points may be determined.

As an example, the controller 130 may identify an expected position of the host vehicle in the adjacent lane, which is expected if the host vehicle makes the lane change to the adjacent lane. For example, the controller 130 may identify the target space corresponding to the expected position and may identify a bounding box (e.g., a bounding box 480 of FIG. 4) corresponding to the target space. The bounding box may indicate one area of the adjacent lane including a target position.

The bounding box may refer to, for example, a figure in a specified shape (e.g., a quadrangle), which surrounds at least a portion of a space (or a target space) between other vehicles. A bounding box may correspond to a defined area or region in the adjacent lane where the host vehicle is expected to move if it changes lanes. Specifically, a bounding box may have a quadrangular shape, as shown by a dashed box (480) in FIG. 4, that surrounds a target space where the host vehicle intends to position itself. The bounding box may assist the autonomous driving of the host vehicle to determine and track a specific area in the adjacent lane, indicating the intended position for the host vehicle or a portion of the target space within the lane.

As an example, if the target space is not identified, the controller 130 may perform lane keeping control without performing biased driving control or lane change control. If the target space is not identified, for example, the controller 130 may identify an average driving speed of at least one other vehicle which is traveling in the adjacent lane using the sensor 110 and may perform lane keeping control to travel in the lane, while controlling the driving speed of the host vehicle to follow the average driving speed. The lane keeping control may refer to maintaining the host vehicle's position within its current lane without attempting any lane changes. If a suitable target space in the adjacent lane is not identified, the controller (e.g., controller 130) may engage lane keeping control to ensure the vehicle remains centered and aligned in its lane. Additionally or alternatively, the controller may adjust the host vehicle's speed to match the average driving speed of other vehicles in the adjacent lane, allowing the host vehicle to travel smoothly and consistently with surrounding traffic, without changing lanes.

For example, if the bounding box corresponding to the target space and at least one box corresponding to the at least one other vehicle overlaps with each other, the controller 130 may perform biased driving control toward the adjacent lane for the host vehicle. To perform a biased driving control, a driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

The at least one box may be, for example, an area corresponding to each of the at least one other vehicle.

As an example, the controller 130 may identify a real-time driving speed of a forward other vehicle which is traveling in front of the host vehicle among the at least one other vehicle, using the sensor 110, and may identify a front box (e.g., a 3-1st box 431 and a 3-2nd box 432 of a third other vehicle 430 of FIG. 4) corresponding to the forward other vehicle to be inversely proportional to the magnitude of the real-time driving speed of the forward other vehicle.

As an example, the controller 130 may identify a real-time driving speed of a following other vehicle which is traveling behind the host vehicle among the at least one other vehicle, using the sensor 110, and may identify a rear box (e.g., a 2-1st box 421 and a 2-2nd box 422 of a second other vehicle 420 of FIG. 4) corresponding to the following other vehicle to be proportional to the magnitude of the real-time driving speed of the following other vehicle.

As an example, the controller 130 may identify a real-time driving speed of the at least one other vehicle, using the sensor 110, and may identify at least one box corresponding to the at least one other vehicle to be inversely proportional to the magnitude of a relative speed between the real-time driving speed and the driving speed of the host vehicle.

As an example, if the bounding box and the at least one box (e.g., 421, 422, 431, 432, 441, or 442 of FIG. 4) corresponding to the at least one other vehicle do not overlap with each other and the size of the bounding box is less than or equal to a specified size, the controller 130 may perform biased driving control. In other words, although the bounding box and the at least one box do not overlap with each other, if the size of the bounding box is less than or equal to the specified size, the controller 130 may hold off a lane change and may perform biased driving control. For example, the controller 130 may generate a bounding box to be inversely proportional to a possibility of collision with the at least one other vehicle, a driving speed of the at least one other vehicle, a remaining distance to an end point of the lane, or the like.

As an example, the controller 130 may determine a maximum value of an amount of biased control based on a width of the lane, a width of the host vehicle, and a margin distance. The amount of biased control may correspond to a lateral offset or deviation from a center of the lane that the controller (e.g., controller 130) may apply to position the host vehicle closer to one side of the lane, for example, near the adjacent lane. This biased positioning may be controlled based on factors such as the width of the lane, the width of the host vehicle, and the margin distance that may help maintain a safe buffer. The margin distance may be, for example, a setting value which is predefined or is changeable by a user. For example, the maximum value may be a value obtained by subtracting a specified ratio (e.g., 50%) of the width of the host vehicle and the margin distance from the specified ratio (e.g., 50%) of the width of the lane. As an example, the controller 130 may set the driving speed of the host vehicle and the margin distance to be proportional to each other. In other words, as the host vehicle travels faster, the controller 130 may more increase the margin distance.

As an example, the controller 130 may perform biased driving control for the host vehicle to be adjacent to the adjacent lane by the amount of biased control smaller than the maximum value.

As an example, the amount of biased control may be set to be proportional to the width of the lane and be inversely proportional to the width of the host vehicle and the margin distance.

As an example, the controller 130 may identify the amount of biased control less than or equal to the determined maximum value, using the expected driving information and the real-time driving information, which are obtained using the sensor 110. For example, the controller 130 may identify an expected arrival time point expected for the host vehicle to reach the target space by the lane change and may identify an adjacent other vehicle expected to be present in front of and behind the host vehicle among the at least one other vehicle at the expected arrival time point. The expected arrival time point may be, for example, a time point expected for the host vehicle to reach the target space if first making a lane change although it is identified that it is impractical to actually make the lane change (e.g., that it is expected to collide with another vehicle if making the lane). For example, the controller 130 may identify the amount of biased control less than or equal to the maximum value, using the expected driving information and the real-time driving information about the host vehicle and the adjacent other vehicle.

The expected driving information may include, for example, an expected headway distance between the adjacent other vehicle and the host vehicle with respect to the expected reach time point, a driving speed of the adjacent other vehicle, an expected distance to a point at which the lane is ended, a size of the bounding box corresponding to the target space, and an expected driving speed of the host vehicle.

The real-time driving information may include, for example, a distance from the current position of the host vehicle and the point at which the lane is ended and a remaining time expected to reach the point at which the lane is ended based on the driving speed.

As an example, the controller 130 may determine an amount of biased control to be inversely proportional to values included in the expected driving information and the real-time driving information. For example, the larger the expected headway distance between the adjacent other vehicle and the host vehicle with respect to the expected arrival time point, the more the controller 130 may decrease the amount of biased control.

As an example, the controller 130 may determine the amount of biased control as any value between a minimum value (e.g., 0) and a maximum value using the above-mentioned parameters. The minimum value may be, for example, an amount of control of a situation in which the host vehicle travels while keeping the lane (or an amount of control if not performing biased driving).

As an example, if it is determined that there is no need to make the lane change or if it is identified that the size of the bounding box is greater than the specified size and that the bounding box and the at least one box do not overlap with each other, the controller 130 may determine the amount of biased control as the minimum value and may perform lane keeping control based on the determined amount of biased control. If the bounding box and the at least one box do not overlap with each other and the size of the bounding box continues being greater than the specified size, the controller 130 may omit biased driving and may immediately perform lane change control.

For example, if it is identified that the size of the bounding box is greater than the specified size and the bounding box and the at least one box do not overlap with each other, the controller 130 may omit or suppress biased driving control and may make a lane change to the target space.

A numerical limitation according to the above-mentioned examples is exemplary, and examples of the present disclosure are not limited thereto. For example, a numerical limitation for a driving speed, acceleration, required acceleration, and braking pressure is exemplary, which may be changed by a setting of a developer and/or a setting of the user.

FIG. 2 shows an example of components and an operation of a vehicle control apparatus according to an example of the present disclosure. In FIG. 2, the vehicle control apparatus comprises an information processing device 212, a driving path generator 220, and a biased amount following device 230. Each of these devices, as well as the sub-devices within the driving path generator (target space determination device 214, biased amount determination device 216, and drivable area determination device 218), may be implemented as dedicated circuit or circuitry configured to perform their respective functions.

According to an example, a vehicle control apparatus (e.g., a vehicle control apparatus 100 of FIG. 1) may include an information processing device 212, a driving path generator 220, a biased amount following device 230. For example, the information processing device 212, the driving path generator 220, and the biased amount following device 230 may be implemented as one device (e.g., a controller 130 of FIG. 1). For example, the driving path generator 220 may include a target space determination device 214, a biased amount determination device 216, and a drivable area determination device 218.

For example, the information processing device 212 may process and obtain pieces of information used to determine whether to perform driving control based on any item among biased driving control for the host vehicle, lane keeping control for the host vehicle, or lane change control for the host vehicle.

As an example, the information processing device 212 may obtain, process, and determine information about a driving speed of the host vehicle, information about whether there is a need to make a lane change, information about whether it is possible to make a lane change, surrounding object information (e.g., information about the at least one other vehicle), information about a speed limit event (e.g., speed limit information of the lane, curvature speed information of the lane, or the like), information about the target space for a lane change, or information about a distance in which it is possible to make a lane change (e.g., a range in which it is possible to make a lane change depending on regulations).

For example, the target space determination device 214 may determine (or predict) a target space in which the host vehicle will be located assuming that the host vehicle makes a lane change. As an example, the target space determination device 214 may determine a target space for a lane change and may calculate a speed trajectory for reaching the space.

For example, if it is determined that there is the need to perform the biased driving control, the biased amount determination device 216 may determine an amount of biased control for controlling the host vehicle to travel close to the adjacent lane. As an example, the biased amount determination device 216 may determine an amount of biased control based on line information about the lane and the adjacent lane, a speed trajectory of the host vehicle, a width of the host vehicle, a width of the lane, a size of the target space, a lane change possibility range, or the like.

For example, the drivable area determination device 218 may determine a safety driving area to travel while preventing a collision with a surrounding object (e.g., at least one other vehicle).

For example, the biased amount following device 230 may perform biased driving control for the host vehicle, based on the amount of biased control determined by the biased amount determination device 216. As an example, the biased amount following device 230 may limit a range in which the biased driving is performed according to the amount of biased control within the safety driving area determined by the drivable area determination device 218 to perform biased driving control.

FIG. 3 shows an example of a situation in which a vehicle control apparatus performs biased driving control or makes a lane change according to an example of the present disclosure.

According to an example, a vehicle control apparatus (e.g., a vehicle control apparatus 100 of FIG. 1) may obtain information about a host vehicle 301 and an object around the host vehicle 301.

For example, the vehicle control apparatus may identify information about the host vehicle 301 and a first other vehicle 302, which are traveling in a lane 391

As an example, the vehicle control apparatus may identify a distance between the host vehicle 301 and the first other vehicle 302. As an example, the vehicle control apparatus may identify a lane change possibility distance da from a current position of the host vehicle 301 to a point at which the lane 391 is ended.

For example, the vehicle control apparatus may identify information about the host vehicle 301 and a second other vehicle 303 which is traveling in an adjacent lane 392.

As an example, the vehicle control apparatus may identify a lateral distance db and a longitudinal distance dc between the host vehicle 301 and the second other vehicle 303.

For example, the vehicle control apparatus may identify a target space based on the pieces of obtained information. A description of identifying the target space may be referenced in detail in a description of FIG. 4, which will be described below.

FIG. 4 shows an example of a situation in which a vehicle control apparatus makes a lane change according to an example of the present disclosure.

According to an example, a vehicle control apparatus (e.g., a vehicle control apparatus 100 of FIG. 1) may obtain information about a host vehicle 401 and an object around the host vehicle 401.

For example, the vehicle control apparatus may identify information about a lane 491 in which the host vehicle 401 is traveling. As an example, the vehicle control apparatus may identify information about a first other vehicle 410 which is traveling in the lane 491. As an example, if identifying that there is an end point 499 at which the lane is ended within a specified distance of the lane 491 from a current position of the host vehicle 401, the vehicle control apparatus may determine that there is a need to make a lane change and may identify a target space and a bounding box 480 corresponding to the target space.

For example, the vehicle control apparatus may identify information about at least one other vehicle which is traveling in an adjacent lane 492 which is a target of the lane change and at least one box corresponding to each of the at least one other vehicle.

As an example, the vehicle control apparatus may identify second boxes 421 and 422 corresponding to a second other vehicle 420. The second boxes 421 and 422 may include the 2-1st box 421 including a rear area of the second other vehicle 420 and the 2-2nd box 422 including a front area of the second other vehicle 420.

As an example, the vehicle control apparatus may identify third boxes 431 and 432 corresponding to a third other vehicle 430. The third boxes 431 and 432 may include the 3-1st box 431 including a rear area of the third other vehicle 430 and the 3-2nd box 432 including a front area of the third other vehicle 430.

As an example, the vehicle control apparatus may identify fourth boxes 441 and 442 corresponding to a fourth other vehicle 440. The fourth boxes 441 and 442 may include the 4-1st box 441 including a rear area of the fourth other vehicle 440 and the 4-2nd box 442 including a front area of the fourth other vehicle 440.

For example, if the bounding box 480 corresponding to the target space and the at least one box do not overlap with each other, the vehicle control apparatus may determine that it is possible to make a lane change. At this time, if the size of the at least one box is less than or equal to a specified size (e.g., if it is determined that it is dangerous to make a lane change, although the boxes do not overlap with each other), the vehicle control apparatus may determine that it is impractical to make the lane change.

For example, if the bounding box 480 corresponding to the target space and the at least one box overlap with each other, the vehicle control apparatus may determine that it is impractical to make the lane change and that there is a need to perform biased driving control.

FIG. 5 shows an example of a situation in which a vehicle control apparatus performs biased driving control according to an example of the present disclosure.

According to an example, a vehicle control apparatus (e.g., a vehicle control apparatus 100 of FIG. 1) may obtain information about a host vehicle 501 and an object around the host vehicle 501.

For example, the vehicle control apparatus may identify information about at least one other vehicle which is traveling in an adjacent lane 592 which is a target of a lane change and at least one box corresponding to each of the at least one other vehicle.

As an example, the vehicle control apparatus may identify second boxes 521 and 522 corresponding to a second other vehicle 520. The second boxes 521 and 522 may include the 2-1st box 521 including a rear area of the second other vehicle 520 and the 2-2nd box 522 including a front area of the second other vehicle 520.

As an example, the vehicle control apparatus may identify third boxes 531 and 532 corresponding to a third other vehicle 530. The third boxes 531 and 532 may include the 3-1st box 531 including a rear area of the third other vehicle 530 and the 3-2nd box 532 including a front area of the third other vehicle 530.

As an example, the vehicle control apparatus may identify fourth boxes 541 and 542 corresponding to a fourth other vehicle 540. The fourth boxes 541 and 542 may include the 4-1st box 541 including a rear area of the fourth other vehicle 540 and the 4-2nd box 542 including a front area of the fourth other vehicle 540.

As an example, the vehicle control apparatus may identify fifth boxes 551 and 552 corresponding to a fifth other vehicle 550. The fifth boxes 551 and 552 may include the 5-1st box 551 including a rear area of the fifth other vehicle 550 and the 5-2nd box 552 including a front area of the fifth other vehicle 550.

For example, the vehicle control apparatus may identify a first other vehicle 510 which is present in front of the host vehicle 501, in a situation in which the host vehicle 501 is traveling in a lane 591.

For example, after determining that there is the need to make the lane change, the vehicle control apparatus may determine whether a bounding box 580 corresponding to a target space and at least one box corresponding to the at least one other vehicle overlap with each other. As shown in FIG. 5, it may be determined that the bounding box 580 overlaps with the 2-2nd box 522 and the 3-1st box 531. Thus, the vehicle control apparatus may determine that it is impractical to quickly make a lane change and may perform biased driving control.

As an example, the vehicle control apparatus may set a driving direction 585 for biased driving of the host vehicle 501. The driving direction 585 may be determined based on an amount of biased control. The larger the amount of biased control, the closer the vehicle control apparatus may control the host vehicle 501 to be to the adjacent lane 592. The host vehicle 501 may perform biased driving like reference numeral 589, based on the biased driving control of the vehicle control apparatus.

FIG. 6 shows an example of a situation in which a vehicle control apparatus performs biased driving control according to an example of the present disclosure.

According to an example, a vehicle control apparatus (e.g., a vehicle control apparatus 100 of FIG. 1) may obtain information about a host vehicle 601 and an object around the host vehicle 601.

For example, the vehicle control apparatus may identify information about at least one other vehicle which is traveling in an adjacent lane 692 which is a target of a lane change and at least one box corresponding to each of the at least one other vehicle.

As an example, the vehicle control apparatus may identify second boxes 621 and 622 corresponding to a second other vehicle 620. The second boxes 621 and 622 may include the 2-1st box 621 including a rear area of the second other vehicle 620 and the 2-2nd box 622 including a front area of the second other vehicle 620.

As an example, the vehicle control apparatus may identify third boxes 631 and 632 corresponding to a third other vehicle 630. The third boxes 631 and 632 may include the 3-1st box 631 including a rear area of the third other vehicle 630 and the 3-2nd box 632 including a front area of the third other vehicle 630.

As an example, the vehicle control apparatus may identify fourth boxes 641 and 642 corresponding to a fourth other vehicle 640. The fourth boxes 641 and 642 may include the 4-1st box 641 including a rear area of the fourth other vehicle 640 and the 4-2nd box 642 including a front area of the fourth other vehicle 640.

As an example, the vehicle control apparatus may identify fifth boxes 651 and 652 corresponding to a fifth other vehicle 650. The fifth boxes 651 and 652 may include the 5-1st box 651 including a rear area of the fifth other vehicle 650 and the 5-2nd box 652 including a front area of the fifth other vehicle 650.

For example, the vehicle control apparatus may identify a first other vehicle 610 which is being stopped or traveling in a lane 691.

For example, the vehicle control apparatus may determine a drivable area 699, using the first other vehicle 610, the at least one other vehicle which is traveling in the adjacent lane 692, and the at least one box. If performing lane keeping control and/or biased driving control for the host vehicle 601, the vehicle control apparatus may control the host vehicle 601 to travel within the drivable area 699.

For convenience, FIG. 7 and FIG. 8 are described by way of an example in which their steps are performed by a processor (e.g., control circuitry). One, some, or all steps of FIG. 7 and FIG. 8, or portions thereof, may be performed by one or more other circuits. One or some of steps of FIG. 7 and FIG. 8 may be omitted, performed in other orders, and/or otherwise modified, and/or one or more additional steps may be added. FIG. 7 shows an example of a vehicle control method according to an example of the present disclosure.

According to an example, a vehicle control apparatus (e.g., a vehicle control apparatus 100 of FIG. 1) may perform operations disclosed in FIG. 7. For example, at least some of components (e.g., a sensor 110, a memory 120, and/or a controller 130 of FIG. 1) included in the vehicle control apparatus may be configured to perform the operations of FIG. 7.

Operations in S710 to S750 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 7, may be briefly described or omitted.

According to an example, in S710, the vehicle control apparatus may identify whether there is a need to perform braking control for a host vehicle.

For example, the vehicle control apparatus may identify whether there is a need to make a lane change while performing autonomous driving control for the host vehicle.

For example, if there is the need to make the lane change (e.g., S710—Yes), the vehicle control apparatus may perform S720.

For example, if there is no need to make the lane change (e.g., S710—No), the vehicle control apparatus may perform S715.

According to an example, in S715, the vehicle control apparatus may perform lane keeping control.

For example, if identifying that there is no need to make the lane change, the vehicle control apparatus may control the host vehicle to continuously travel in a lane.

According to an example, in S720, the vehicle control apparatus may determine whether a target space for the lane change is identified.

For example, if the target space is identified (e.g., S720—Yes), the vehicle control apparatus may perform S730.

For example, if the target space is not identified (e.g., S720—No), the vehicle control apparatus may perform S725.

According to an example, in S725, the vehicle control apparatus may control the host vehicle to keep the lane and follow a driving speed in a target lane.

For example, if there is the need to make the lane change, but the target space is not identified, the vehicle control apparatus may perform driving control such that the host vehicle follows an average driving speed in an adjacent lane to travel while keeping the lane.

According to an example, in S730, the vehicle control apparatus may determine whether it is possible to make a lane change using the target space.

For example, if it is possible to make the lane change using the target space (e.g., S730—Yes), the vehicle control apparatus may perform S735.

For example, if it is not possible to make the lane change using the target space (e.g., S730—No), the vehicle control apparatus may perform S740.

According to an example, in S735, the vehicle control apparatus may control the host vehicle to make the lane change to an adjacent lane.

According to an example, in S740, the vehicle control apparatus may determine whether there is a need to perform biased driving.

For example, if there is the need to perform the biased driving (e.g., S740—Yes), the vehicle control apparatus may perform S750.

For example, if there is no need to perform the biased driving (e.g., S740—No), the vehicle control apparatus may perform S715.

According to an example, in S750, the vehicle control apparatus may perform biased driving control.

For example, the vehicle control apparatus may perform biased driving control, based on an amount of biased control determined based on information of the host vehicle and at least one other vehicle.

FIG. 8 shows an example of a vehicle control method according to an example of the present disclosure.

According to an example, a vehicle control apparatus (e.g., a vehicle control apparatus 100 of FIG. 1) may perform operations disclosed in FIG. 8. For example, at least some of components (e.g., a sensor 110, a memory 120, and/or a controller 130 of FIG. 1) included in the vehicle control apparatus may be configured to perform the operations of FIG. 8.

Operations in S810 to S860 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 8, may be briefly described or omitted.

According to an example, in S810, the vehicle control apparatus may determine whether there is a need to make a lane change, based on a characteristic of a lane and a driving path of a host vehicle, which are obtained using a sensor.

According to an example, in S820, the vehicle control apparatus may determine whether there is a need to make a lane change.

For example, if there is the need to make the lane change (e.g., S820—Yes), the vehicle control apparatus may perform S830.

For example, if there is no need to make the lane change (e.g., S820-No), the vehicle control apparatus may perform S825.

According to an example, in S825, the vehicle control apparatus may perform lane keeping control.

For example, if identifying that there is no need to make the lane change, the vehicle control apparatus may control the host vehicle to continuously travel in a lane.

According to an example, in S830, the vehicle control apparatus may determine whether a target space for the lane change is identified.

For example, if the target space is identified (e.g., S830—Yes), the vehicle control apparatus may perform S840.

For example, if the target space is not identified (e.g., S830-No), the vehicle control apparatus may perform S825.

According to an example, in S840, the vehicle control apparatus may identify a bounding box corresponding to the target space and at least one box corresponding to at least one other vehicle.

According to an example, in S850, the vehicle control apparatus may determine whether the bounding box and the at least one box overlap with each other.

For example, if the bounding box and the at least one box overlap with each other (e.g., S850—Yes), the vehicle control apparatus may perform S860.

For example, if the bounding box and the at least one box do not overlap with each other (e.g., S850-No), the vehicle control apparatus may perform S855.

According to an example, in S855, the vehicle control apparatus may make the lane change to an adjacent lane.

According to an example, in S860, the vehicle control apparatus may perform biased driving control.

FIG. 9 shows an example of a computing system about a vehicle control apparatus or a vehicle control method according to an example of the present disclosure.

Referring to FIG. 9, a computing system 1000 about the vehicle control apparatus or the vehicle control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC).

The ASIC may reside within a user terminal. In another case, the processor and the storage medium may reside in the user terminal as separate components.

The present disclosure has been made to solve the above-mentioned problems occurring in the related art while advantages achieved by the related art are maintained intact.

An example of the present disclosure provides a vehicle control apparatus for performing control (e.g., biased driving control) for a host vehicle to be adjacent to an adjacent lane which is a lane change target, if it is identified that it is impractical to quickly make a lane change, in a situation in which there is a need to make the lane change, to quickly and safely deliver an intention of the host vehicle to make the lane change to at least one other vehicle in an adjacent lane and a method thereof.

Another example of the present disclosure provides a vehicle control apparatus for safely performing biased driving control, using an amount of biased control determined based on information about at least one other vehicle which is traveling in an adjacent lane (e.g., a driving speed of the at least one other vehicle, a relative speed between the at least one other vehicle and a host vehicle, a headway distance between the at least one other vehicle, a distance between the at least one other vehicle and a target space, or the like) and a method thereof.

Another example of the present disclosure provides a vehicle control apparatus for omitting biased driving control and immediately making a lane change, if it is identified that it is possible to make the lane change, to minimize an unnecessary process and provide a user with an optimal driving environment and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a sensor, a memory storing at least one instruction, and a controller operatively connected with the sensor and the memory. For example, the at least one instruction may be configured to, when executed by the controller, cause the vehicle control apparatus to determine whether there is a need to make a lane change, based on a characteristic of a lane and a driving path of a host vehicle, the characteristic and the driving path being obtained using the sensor, identify a target space in an adjacent lane for the lane change using a current position of the host vehicle, a driving speed of the host vehicle, and information about at least one other vehicle which is traveling in the adjacent lane, if it is determined that there is the need to make the lane change, and perform biased driving control toward the adjacent lane for the host vehicle, if a bounding box corresponding to the target space and at least one box corresponding to the at least one other vehicle overlap with each other.

According to an example, the at least one instruction may be configured to, when executed by the controller, cause the vehicle control apparatus to determine that there is the need to make the lane change, if there is a point at which the lane is ended within a specified distance of the lane or identifying a situation of having to travel in the adjacent lane based on the driving path.

According to an example, the at least one instruction may be configured to, when executed by the controller, cause the vehicle control apparatus to identify an average driving speed of the at least one other vehicle which is traveling in the adjacent lane using the sensor, if the target space is not identified, and adjust the driving speed of the host vehicle to follow the average driving speed and perform lane keeping control for traveling on the lane.

According to an example, the at least one instruction may be configured to, when executed by the controller, cause the vehicle control apparatus to perform the biased driving control, if the bounding box and the at least one box corresponding to the at least one other vehicle do not overlap with each other and a size of the bounding box is less than or equal to a specified size.

According to an example, the at least one instruction may be configured to, when executed by the controller, cause the vehicle control apparatus to determine a maximum value of an amount of biased control, based on a width of the lane, a width of the host vehicle, and a margin distance, and perform the biased driving control for the host vehicle to be adjacent to the adjacent lane by the amount of biased control smaller than the maximum value. For example, the amount of biased control may be set to be proportional to the width of the lane and be inversely proportional to the width of the host vehicle and the margin distance.

According to an example, the at least one instruction may be configured to, when executed by the controller, cause the vehicle control apparatus to set the driving speed of the host vehicle and the margin distance to be proportional to each other.

According to an example, the at least one instruction may be configured to, when executed by the controller, cause the vehicle control apparatus to identify an expected arrival time point expected for the host vehicle to reach the target space by the lane change, identify an adjacent other vehicle expected to be present in front of and behind the host vehicle among the at least one other vehicle, at the expected arrival time point, identify expected driving information including an expected headway distance between the adjacent other vehicle and the host vehicle with respect to the expected reach time point, a driving speed of the adjacent other vehicle, an expected distance to a point at which the lane is ended, a size of the bounding box corresponding to the target space, and an expected driving speed of the host vehicle, identify real-time driving information including a distance from the current position of the host vehicle and the point at which the lane is ended and a remaining time expected to reach the point at which the lane is ended based on the driving speed, and determine the amount of biased control less than or equal to the maximum value, using the expected driving information and the real-time driving information.

According to an example, the at least one instruction may be configured to, when executed by the controller, cause the vehicle control apparatus to determine the amount of biased control to be inversely proportional to values included in the expected driving information and the real-time driving information.

According to an example, the at least one instruction may be configured to, when executed by the controller, cause the vehicle control apparatus to determine the amount of biased control as a minimum value, if it is determined that there is no need to make the lane change or if it is identified that a size of the bounding box is greater than a specified size or the bounding box and the at least one box do not overlap with each other, and perform lane keeping control, based on the determined amount of biased control.

According to an example, the at least one instruction may be configured to, when executed by the controller, cause the vehicle control apparatus to omit the biased driving control and make the lane change to the target space, if it is identified that a size of the bounding box is greater than a specified size and the bounding box and the at least one box do not overlap with each other.

According to an example, the at least one instruction may be configured to, when executed by the controller, cause the vehicle control apparatus to identify a real-time driving speed of a forward other vehicle which is traveling in front of the host vehicle among the at least one other vehicle, using the sensor and identify a front box corresponding to the forward other vehicle to be inversely proportional to a magnitude of the real-time driving speed of the forward other vehicle.

According to an example, the at least one instruction may be configured to, when executed by the controller, cause the vehicle control apparatus to identify a real-time driving speed of a following other vehicle which is traveling behind the host vehicle among the at least one other vehicle, using the sensor, and identify a rear box corresponding to the following other vehicle to be proportional to a magnitude of the real-time driving speed of the following other vehicle.

According to an example, the at least one instruction may be configured to, when executed by the controller, cause the vehicle control apparatus to identify a real-time driving speed of the at least one other vehicle, using the sensor and identify the at least one box corresponding to the at least one other vehicle to be inversely proportional to a magnitude of a relative speed between the real-time driving speed and the driving speed of the host vehicle.

According to another example of the present disclosure, a vehicle control method may include determining, by a controller, whether there is a need to make a lane change, based on a characteristic of a lane and a driving path of a host vehicle, the characteristic and the driving path being obtained using a sensor, identifying, by the controller, a target space in an adjacent lane for the lane change using a current position of the host vehicle, a driving speed of the host vehicle, and information about at least one other vehicle which is traveling in the adjacent lane, if it is determined that there is the need to make the lane change, and performing, by the controller, biased driving control toward the adjacent lane for the host vehicle, if a bounding box corresponding to the target space and at least one box corresponding to the at least one other vehicle overlap with each other.

According to an example, the vehicle control method may further include determining, by the controller, that there is the need to make the lane change, if there is a point at which the lane is ended within a specified distance of the lane or identifying a situation of having to travel in the adjacent lane based on the driving path.

According to an example, the vehicle control method may further include identifying, by the controller an average driving speed of the at least one other vehicle which is traveling in the adjacent lane using the sensor, if the target space is not identified, and adjusting, by the controller, the driving speed of the host vehicle to follow the average driving speed and performing, by the controller, lane keeping control for traveling on the lane.

According to an example, the vehicle control method may further include performing, by the controller, the biased driving control, if the bounding box and the at least one box corresponding to the at least one other vehicle do not overlap with each other and a size of the bounding box is less than or equal to a specified size.

According to an example, the vehicle control method may further include determining, by the controller, a maximum value of an amount of biased control, based on a width of the lane, a width of the host vehicle, and a margin distance, and performing, by the controller, the biased driving control for the host vehicle to be adjacent to the adjacent lane by the amount of biased control smaller than the maximum value. For example, the amount of biased control may be set to be proportional to the width of the lane and be inversely proportional to the width of the host vehicle and the margin distance.

According to an example, the vehicle control method may further include setting, by the controller, the driving speed of the host vehicle and the margin distance to be proportional to each other.

According to an example, the vehicle control method may further include identifying, by the controller, an expected arrival time point expected for the host vehicle to reach the target space by the lane change, identifying, by the controller, an adjacent other vehicle expected to be present in front of and behind the host vehicle among the at least one other vehicle, at the expected arrival time point, identifying, by the controller, expected driving information including an expected headway distance between the adjacent other vehicle and the host vehicle with respect to the expected reach time point, a driving speed of the adjacent other vehicle, an expected distance to a point at which the lane is ended, a size of the bounding box corresponding to the target space, and an expected driving speed of the host vehicle, identifying, by the controller, real-time driving information including a distance from the current position of the host vehicle and the point at which the lane is ended and a remaining time expected to reach the point at which the lane is ended based on the driving speed, and determining, by the controller, the amount of biased control less than or equal to the maximum value, using the expected driving information and the real-time driving information.

A description will be given of effects of the vehicle control apparatus and the method thereof according to an example of the present disclosure.

Examples of the present disclosure may perform control (e.g., biased driving control) for the host vehicle to be adjacent to an adjacent lane which is a lane change target, if it is identified that it is impractical to quickly make a lane change, in a situation in which there is a need to make the lane change, thus quickly and safely delivering an intention of the host vehicle to make the lane change to at least one other vehicle in the adjacent lane.

Examples of the present disclosure may safely perform biased driving control, using an amount of biased control determined based on information about at least one other vehicle which is traveling in an adjacent lane (e.g., a driving speed of the at least one other vehicle, a relative speed between the at least one other vehicle and the host vehicle, a headway distance between the at least one other vehicle, a distance between the at least one other vehicle and a target space, or the like).

Examples of the present disclosure may omit biased driving control and immediately make a lane change, if it is identified that it is possible to make the lane change, thus minimizing an unnecessary process and providing a user with an optimal driving environment.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the exemplary purpose. The scope of the present disclosure should be construed on the basis of the accompanying claims, and all the technical ideas within the scope equivalent to the claims should be included in the scope of the present disclosure.

What is claimed is:

1. An apparatus for controlling driving of a vehicle, the apparatus comprising:
a sensor configured to obtain a characteristic of a lane and a driving path of the vehicle;
a memory storing at least one instruction; and
a processor operatively coupled to the sensor and the memory,
wherein the at least one instruction is configured to, when executed by the processor, cause the apparatus to:
determine, based on the characteristic and the driving path, whether to make a lane change;
identify a target space in an adjacent lane for the lane change based on a determination to make the lane change, a current position of the vehicle, a driving speed of the vehicle, and information about at least one other vehicle which is traveling in the adjacent lane; and
perform, based on a bounding box corresponding to the target space and at least one box corresponding to the at least one other vehicle overlapping with each other, biased driving control toward the adjacent lane for the vehicle.

2. The apparatus of claim 1, wherein the at least one instruction is configured to, when executed by the processor, cause the apparatus to:
determine to make the lane change based on at least one of:
a presence of a point at which the lane is ended within a specified distance of the lane, or
identifying a situation of having the vehicle to travel in the adjacent lane based on the driving path.

3. The apparatus of claim 1, wherein the at least one instruction is configured to, when executed by the processor, cause the apparatus to:
determine, based on information from the sensor and based on the target space not being determined, an average driving speed of the at least one other vehicle which is traveling in the adjacent lane;
adjust the driving speed of the vehicle to follow the average driving speed; and
perform lane keeping control for the vehicle traveling on the lane.

4. The apparatus of claim 1, wherein the at least one instruction is configured to, when executed by the processor, cause the apparatus to:
perform, based on the bounding box and the at least one box not overlapping with each other and a size of the bounding box being less than or equal to a specified size, the biased driving control for the vehicle.

5. The apparatus of claim 1, wherein the at least one instruction is configured to, when executed by the processor, cause the apparatus to:
determine, based on a width of the lane, a width of the vehicle, and a margin distance, a maximum value of an amount of the biased driving control; and
perform the biased driving control for the vehicle to be adjacent to the adjacent lane by a value of the amount of the biased driving control, wherein the value is smaller than the maximum value, and
wherein the amount of the biased driving control is set to be proportional to the width of the lane and be inversely proportional to the width of the vehicle and the margin distance.

6. The apparatus of claim 5, wherein the at least one instruction is configured to, when executed by the processor, cause the apparatus to:
set the driving speed of the vehicle and the margin distance to be proportional to each other.

7. The apparatus of claim 5, wherein the at least one instruction is configured to, when executed by the processor, cause the apparatus to:
determine an expected arrival time point expected for the vehicle to reach the target space by the lane change;
determine an adjacent other vehicle among the at least one other vehicle, wherein the adjacent other vehicle is expected to be present in front and behind of the vehicle at the expected arrival time point;
determine expected driving information, wherein the expected driving information comprises:
an expected headway distance between the adjacent other vehicle and the vehicle with respect to an expected reach time point,
a driving speed of the adjacent other vehicle,
an expected distance to a point at which the lane is ended,
a size of the bounding box corresponding to the target space, and
an expected driving speed of the vehicle;
determine real-time driving information, wherein the real-time driving information comprises:
a distance from the current position of the vehicle to the point at which the lane is ended, and
a remaining time expected to reach, based on the driving speed, the point at which the lane is ended; and
determine, based on the expected driving information and the real-time driving information, a second value of the amount of the biased driving control, wherein the second value of the amount of the biased driving control is less than or equal to the maximum value.

8. The apparatus of claim 7, wherein the at least one instruction is configured to, when executed by the processor, cause the apparatus to:
determine the amount of the biased driving control to be inversely proportional to values included in the expected driving information and the real-time driving information.

9. The apparatus of claim 5, wherein the at least one instruction is configured to, when executed by the processor, cause the apparatus to:
determine a value of the amount of the biased driving control as a minimum value based on at least one of:
a determination not to make the lane change,
a size of the bounding box being greater than a specified size, or
the bounding box and the at least one box not overlapping with each other; and
perform, based on the determined value of the amount of the biased driving control, lane keeping control.

10. The apparatus of claim 1, wherein the at least one instruction is configured to, when executed by the processor, cause the apparatus to:
suppress the biased driving control and make the lane change to the target space based on a size of the bounding box being greater than a specified size and based on the bounding box and the at least one box not overlapping with each other.

11. The apparatus of claim 1, wherein the at least one instruction is configured to, when executed by the processor, cause the apparatus to:
determine, based on information from the sensor, a real-time driving speed of a forward other vehicle among the at least one other vehicle, wherein the forward other vehicle is traveling in front of the vehicle; and
determine a front box corresponding to the forward other vehicle to be inversely proportional to a magnitude of the real-time driving speed of the forward other vehicle.

12. The apparatus of claim 1, wherein the at least one instruction is configured to, when executed by the processor, cause the apparatus to:
determine, based on information from the sensor, a real-time driving speed of a following other vehicle among the at least one other vehicle, wherein the following other vehicle is traveling behind the vehicle; and
determine a rear box corresponding to the following other vehicle to be proportional to a magnitude of the real-time driving speed of the following other vehicle.

13. The apparatus of claim 1, wherein the at least one instruction is configured to, when executed by the processor, cause the apparatus to:
determine, based on information from the sensor, a real-time driving speed of the at least one other vehicle; and
determine the at least one box corresponding to the at least one other vehicle to be inversely proportional to a magnitude of a speed difference between the real-time driving speed and the driving speed of the vehicle.

14. A method performed by an apparatus for controlling driving of a vehicle, the method comprising:
determining, based on a characteristic of a lane and a driving path of the vehicle obtained from a sensor, whether to make a lane change;
identifying a target space in an adjacent lane for the lane change based on a determination to make the lane change, a current position of the vehicle, a driving speed of the vehicle, and information about at least one other vehicle which is traveling in the adjacent lane; and
performing, based on a bounding box corresponding to the target space and at least one box corresponding to the at least one other vehicle overlapping with each other, biased driving control for the vehicle toward the adjacent lane.

15. The method of claim 14, wherein the determining whether to make the lane change comprises determining to make the lane change based on at least one of:
a presence of a point at which the lane is ended within a specified distance of the lane, or
identifying a situation of having the vehicle to travel in the adjacent lane based on the driving path.

16. The method of claim 14, further comprising:
determining, based on information from the sensor and based on the target space not being determined, an average driving speed of the at least one other vehicle which is traveling in the adjacent lane;
adjusting the driving speed of the vehicle to follow the average driving speed; and
performing lane keeping control for the vehicle traveling on the lane.

17. The method of claim 14, further comprising:
performing, based on the bounding box and the at least one box not overlapping with each other and a size of the bounding box being less than or equal to a specified size, the biased driving control for the vehicle.

18. The method of claim 14, further comprising:
determining, based on a width of the lane, a width of the vehicle, and a margin distance, a maximum value of an amount of the biased driving control; and
performing the biased driving control for the vehicle to be adjacent to the adjacent lane by a value of the amount of the biased driving control, where in the value is smaller than the maximum value,
wherein the amount of the biased driving control is set to be proportional to the width of the lane and be inversely proportional to the width of the vehicle and the margin distance.

19. The method of claim 18, further comprising:
setting the driving speed of the vehicle and the margin distance to be proportional to each other.

20. The method of claim 18, further comprising:
determining an expected arrival time point expected for the vehicle to reach the target space by the lane change;
determining an adjacent other vehicle among the at least one other vehicle, wherein the adjacent other vehicle is expected to be present in front and behind of the vehicle at the expected arrival time point;
determining expected driving information, wherein the expected driving information comprises:
an expected headway distance between the adjacent other vehicle and the vehicle with respect to an expected reach time point,
a driving speed of the adjacent other vehicle,
an expected distance to a point at which the lane is ended,
a size of the bounding box corresponding to the target space, and
an expected driving speed of the vehicle;
determining real-time driving information, wherein the real-time driving information comprises:
a distance from the current position of the vehicle to the point at which the lane is ended, and
a remaining time expected to reach, based on the driving speed, the point at which the lane is ended; and
determining, based on the expected driving information and the real-time driving information, a second value of the amount of the biased driving control, wherein the second value of the amount of the biased driving control is less than or equal to the maximum value.
